(19) United States
(12) Patent Application Publication
(10) Pub. No.: US 2014/0147574 A1
(43) Pub. Date: May 29, 2014

(54) REDUCED-CALORIE AND DIGESTION-PROMOTING FOODS

(71) Applicant: MONDO MINERALS DEUTSCHLAND GMBH, (US)

(72) Inventor: Wulf-Dietrich Keller, Bad Orb (DE)

(21) Appl. No.: 14/116,777

(22) PCT Filed: Mar. 30, 2012
(86) PCT No.: PCT/EP2012/005585

§ 371 Date: Feb. 13, 2014

(30) Foreign Application Priority Data
May 9, 2011 (EP) 11165346.5

(51) Int. Cl. A23L 1/304

(52) U.S. Cl. CPC A23L 1/304
USPC 426/648

(57) ABSTRACT

The invention relates to reduced-calorie and digestion-promoting foods that have a calorific value-containing portion and are mixed with talc. Calorific value-containing components of the calorific value-containing portion are selected from the group consisting of carbohydrates, proteins and fats. Sugars are to be subsumed under carbohydrates. The invention relates to a food that has a calorific value-containing portion, wherein talc composes at least 15 wt % and no more than 40 wt % of the food relative to the total weight of the food.

The present invention relates to reduced-calorie and digestion-promoting foods that have a calorific value-containing portion and are mixed with talc. The present invention further relates to the use of talc for reducing the calorific value of foods.

Calorific value-containing portions are selected from the group consisting of carbohydrates, proteins and fats. Sugars are to be subsumed under carbohydrates.

Today, overweight of the population of the developed nations is a factor which considerably compromises health. In comparison to the year 1999 (56% of men and 40% of women) the portion of overweight individuals has remarkably increased. According to the Federal Statistical Office in the year 2009 a total of 51% of the adult population were overweight, 60% of men and 43% of women. Besides increased weight bearing of bones and joints, overweight also results in cardiovascular diseases and many other medical conditions such as for example the metabolic syndrome. According to opinion polls about the state of health of the year 2009, just under 15% of the population which gave particulars about their state of health are of the opinion that their health is compromised, so the Federal Statistical Office of Germany. Such persons considerably more often were afflicted with overweight or strong overweight than persons with an assessment of good health.

Evidentially, physical inactivity and an associated caloric intake which is too high are responsible for overweight. A further problem is that the diet of many human beings with respect to quantity and quality is not a healthy and balanced one. For example, a dish rich in carbohydrates after the food intake results in release of insulin. Insulin, also referred to as storage hormone, effects the storage of energy reserves, in particular of fat in fat cells and the lowering of the level of blood sugar. Thus, nutritionally fat- and carbohydrate-containing foods particularly have to be called into question. Even more problematic are fat- and sugar-containing dishes which applies to most sweet desserts, because fat is used as a flavor carrier. Here, the sugar in the food is responsible for a quick release of insulin. Under these conditions, fats will optimally be digested and resorbed. Thereafter, insulin results in the formation of fat reserves in the fat cells. Furthermore, a quick increase of the level of insulin results in a quick conversion of sugar into glycogen and thus in a decrease of the level of blood sugar causing a feeling of hunger, so that after a time which is too short food will be ingested again. The consequence is overweight.

With the ingestion of food fat plays an important role with respect to the amount of kilocalories being taken in. One gram of fat has a nutritional value of 9.3 kilocalories, while one gram of carbohydrates corresponds to 6.2 kilocalories, and one gram of protein corresponds to 4.1 kilocalories. Therefore, fatty dishes particularly contribute to overweight which even more applies to sweet fatty dishes due to the above mentioned reasons.

Besides overweight caries is a widespread disease in all groups of the population of the developed nations, in particular in children. The intake of sugar- and/or carbohydrate-containing foods and their continuance in the mouth is inter alia the reason for the clinical picture of caries. In the mouth carbohydrates are degraded into sugar by the enzymes of the salivary juice. Sugar contributes to multiplying of caries bacteria in the mouth which are also a reason for the clinical picture of caries.

In addition, malnutrition and/or physical inactivity may cause digestive problems, and sluggishness of the bowels up to obstipation are widespread problems. The use of chemical laxatives being possible without prescription and without any control of an attending physician is assessed as extremely problematic. Chronic abuse and negative consequences associated therewith are a problem in our society today. However, fiber-rich foods which may also solve this problem are less popular in large parts of the population.

In EP 0 338 931 B1 products are described which are an emulsion of an aqueous phase and an oily phase, wherein the oily phase contains paraffin hydrocarbons mixed with fat-soluble lecithin in an amount of between 0.01 and 5 wt %, wherein the aqueous phase is characterized by an extract of water-dispersible lecithin being enriched with phosphatidylcholine in an amount of between 0.01 and 5 wt %. In addition, such products may also contain a mineral powder, also talc. The reduction of the calorie content of the products is effected by the replacement of fat as described.

DE 3 532 283 A1 describes a method for the preservation of foods, wherein small amounts of flour and/or mineral nutrients can be used for preservation.

BG 0 109 308 A and RU 2 376 888 C2 describe dietary supplements which inter alia may contain flour and talc.

U.S. Pat. No. 2,444,215 A describes a flour which can easily be used and is diluted with starch mixtures and which for example is enriched with vitamins. In addition, the starch mixture may also contain talc, but only for improving the flow characteristics thereof and not however as a replacement for the calorific value-containing portion. For the production of foods this mixture in turn is added to a flour in a portion of 0.13 wt %.

Patent application EP 1 104 656 A1 exclusively describes a fat substitute, wherein as a possible substitute material a composition of finest particles or particles having a hydrophobic coating is described which do not negatively influence the baking process. As a substitute material inorganic or organic substances with defined oil absorption are used.

Finally, DE 2 538 076 A1 describes a process for the production of a quick-cooking rice, wherein the rice is mixed and gelatinized with e.g. talc and may subsequently be mixed with flour or talc.

Also fiber-rich reduced-calorie sweets are known (database GNPD, accession no. 618612) which may contain talc as an additional component, for example for regulating moisture.

There is a great need for calorific value-containing foods, i.e. foods having a calorific value-containing portion which are reduced in calories, i.e. have a low nutritional value, but at the same time however do not lose taste. In addition, the foods should promote the digestion and ideally reduce the resorption of fats or their components in the bowel. Furthermore, the foods should have a pleasant haptic in the mouth and thus cause a pleasant feeling. In addition, the reduced-calorie calorific value-containing foods should have high storage stability.

Thus, there is also a need for a substance which can be added to foods and thus for the respective food for achieving the above mentioned properties. Ideally, such a substance can be used for the reduction of calories in foods such that different calorific value-containing portions, namely carbohydrate-containing and/or fat-containing portions, can alternatively be replaced in foods. In particular there is a need for a substance which can replace carbohydrate-containing portions in a food, in particular in flour.

Further requirements for such a substance are that it does not increase the price of food, but, if possible, even reduce it. Ideally, the food can be produced at lower temperatures which saves energy and thus further can reduce the costs of the food through lower production costs.

All mentioned objects of the present invention can surprisingly be achieved by the addition of at least 15 wt % of talc to a food relative to the whole food having a calorific value-containing portion.

In the foods according to the present invention calorific value-containing components such as carbohydrates, in particular flour independent of the type and the fineness of grinding, and/or proteins and/or fats can be replaced by talc.

Furthermore, the food may contain indigestible substances such as fibers, cellulose or the like, water or aqueous components, other mineral nutrients than talc, trace elements, dyes and other miscellaneous components which are suitable for consumption.

Talc (in pulverized form talcum) which is also known as steatite or under its chemical name magnesium silicate hydrate is a commonly occurring mineral of the mineral class of silicates and germanates. Talc is an officially approved food additive with the number E 553b in the EU. For mixing the foods with talc according to the present invention a person skilled in the art will select a talc which is of suitable purity and which is therefore non-hazardous in the case of consumption. Due to its non-hazardousness to health the substance is not only used in foods, but also in the cosmetic and drug industry.

Talc has a series of properties which qualify it for these uses: Besides its non-hazardousness to health it is a substance which is excreted in undigested form and thus has a nutritional value of zero. In food industry already today it is used as a tasteless non-stick agent, e.g. in cheese slices, sausages, etc.

According to the present invention a food is a substance which is suitable for consumption or a mixture of different substances which are suitable for consumption serving as a diet in the sense of energy feed. In the sense of the present invention the meaning of the term “food” does not comprise dietary supplements. Dietary supplements are agents serving for the provision of substances which in the first instance are not energy carriers. Examples of such substances are vitamins and trace elements.

The addition of at least 15 wt % of talc relative to the total weight of the food to a food with at least one calorific value-containing portion results in different advantages. This also applies to the addition of no more than 40 wt % of talc relative to the total weight of the food. These advantages are also effected in the case of an addition of at least 15.05 wt % of talc and of no more than 39.5 wt % of talc.
The food contains less fat.
The food contains fewer carbohydrates.
The food contains less fat and fewer carbohydrates.
The calorie content of the food is reduced remarkably.
The food causes less caries.
The food as a so-called “bulking agent” has a volume-increasing effect in the bowel and thus has a digestion-promoting effect.
The food can reduce the resorption of fats or their components from the bowel and thus has a positive effect onto the lipid metabolism.
The food is cheaper than the respective food in which no replacement has been conducted.
The shelf life of the food is improved.
The dehydration of the food does not happen in such a short time as in the case of a respective food in which no replacement has been conducted.
The food can be produced and finished in a cheap and environmentally friendly manner using of less energy. In particular the baking of a food according to the present invention can be conducted in an energy-saving manner.

The reduced nutritional value of the food according to the present invention makes it suitable for a nutrition-conscious diet, for example in the case of overweight and obesity/adiposity. According to the present invention a reduced nutritional value means a reduction of the nutritional value of at least 22.5%. With respect to a food according to a standard recipe without the addition of talc a food according to the present invention preferably has a nutritional value which is reduced in an amount of ≧30%, further preferably ≧35% and particularly preferably ≧38%.

A reduced content of carbohydrates makes the food suitable for a reduced-calorie diet, in particular also in the case of obesity, since after its consumption less insulin is released and thus less fat reserves are build up. This effect is particularly distinctive in the case, when in a food the addition of talc does replace carbohydrate-containing portions as well as fat-containing portions.

Foods with a reduced amount of carbohydrates are for example also suitable for diabetics.

The price of talc which is lower in comparison to a typical carbohydrate-containing portion in a food, such as for example flour, makes the food taken as a whole cheaper. This is also the case, when a fat-containing portion in a food is replaced by talc.

According to the present invention a food having a calorific value-containing portion is provided, characterized in that at least 15 wt % relative to the total weight of the food are present in the food. Up to 40 wt % of talc may be present in the food relative to the total weight of the food.

The calorific value-containing portion consists of calorific value-containing components. Calorific value-containing components are selected from carbohydrates, proteins and fats. The calorific value-containing portion may only consist of one calorific value-containing component.

However preferably, the calorific value-containing portion consists of at least two calorific value-containing components, selected from carbohydrates, fats and proteins. The food according to the present invention preferably comprises 0.01 to 85 wt % of carbohydrates, 0.01 to 80 wt % of proteins and 0 to 80 wt % of fats relative to the total weight of the food. In an alternative embodiment a food according to the present invention comprises 0.01 to 85 wt % of carbohydrates, 0 to 80 wt % of proteins and 0.01 to 80 wt % of fats relative to the total weight of the food.

In a particular embodiment according to the present invention the calorific value-containing portion consists of three calorific value-containing components, i.e. of a carbohydrate, a fat and a protein component.

Preferably, the calorific value-containing portion is at least 50 wt % relative to the whole food. More preferably, the calorific value-containing portion of the food is at least 70 wt % and particularly preferably at least 85 wt % of the total mass of the food.

If according to the present invention ranges of amounts of any component in the food are mentioned, a person skilled in the art will always consider respective lower limits and upper limits independently from each other and thus combine them with one another.

Preferably, 50 wt % of carbohydrates are present in the food relative to the whole food. In a more preferable embodiment the portion of carbohydrates in the food has a value of at least 65 wt %, particularly preferably at least 80 wt % relative to the total mass of the food.

Preferable amounts of carbohydrates in the food are between 50 wt % and 80 wt % relative to the whole food.

According to a further embodiment at least 30 wt % of fat are present in the food relative to the whole food.

In a preferable embodiment the portion of fat in the food is at least 40 wt %, particularly preferably at least 50 wt % relative to the total mass of the food.

Fat may be present in the food in amounts of between 30 wt % and 50 wt % relative to the whole food.

Foods in which according to the present invention calorific value-containing portions are replaced completely or partially by talc contain a portion of protein of preferably not lower than 10 wt %, more preferably not lower than 20 wt % and particularly preferably not lower than 25 wt % relative to the total mass of the food.

According to a further embodiment in the food at least 30 wt % of protein are present relative to the whole food. Protein may be present in the food in amounts of between 30 wt % and 80 wt % relative to the whole food.

In addition, the food may contain indigestible components and components without any calorific value, such as fibers, minerals or mineral nutrients which are different from talc, food components which cannot be digested by the human organism, such as cellulose, etc., aqueous portions or other consumable portions, for example in amount of at least 10 wt % relative to the whole food.

According to the present invention the portion of talc in the food should not fall below a value of at least 15 wt % and preferably at least 20 wt % relative to the total weight of the food to guarantee a reduction of the nutritional value which is sufficient. More preferably, at least 25.5 wt % of talc are contained in the food. In a particular embodiment of the present invention at least 28 wt % of talc are contained in the food relative to the total weight of the food.

According to the present invention no more than 40 wt % of talc are present in the food relative to the total weight of the food to still guarantee a calorific value-containing portion which is sufficient. Particularly preferably, the portion of talc relative to the total weight of the food is no more than 37 wt %. In a further preferable embodiment of the invention the content of talc in the food is no more than 35 wt % relative to the total weight of the food. In a particular embodiment no more than 32.5 wt % of talc are contained in the food relative to the total weight of the food.

In a preferable embodiment of the invention only one calorific value-containing component of the food is partially or completely replaced by talc.

In a further preferable embodiment two calorific value-containing components of the food are partially or completely replaced by talc. In a further preferable embodiment of the invention three calorific value-containing components of the food are partially or completely replaced by talc.

Preferably, 15 wt % to 35 wt % of talc are present in the food relative to the total weight of the food.

According to the present invention preferably at least 15 wt % of at least one calorific value-containing component of the food are replaced by talc relative to the total weight of the food. More preferable, between 15 wt % and 40 wt % of at least one calorific value-containing component of the food are replaced by talc relative to the total weight of the food.

According to a further embodiment in the food between 10 wt % and 25 wt % of a fat are replaced by talc relative to the total weight of the food, wherein in the food in total 15 to 40 wt % of talc are contained relative to the whole food.

According to a further embodiment in the food between 10 wt % and 40 wt % of a carbohydrate are replaced by talc relative to the total weight of the food, wherein in the food in total 15 to 40 wt % of talc are contained relative to the whole food.

Surprisingly, during the implementation of the present invention it has been shown that for example bakery products which have been mixed with talc exhibit a lower dehydration rate than respective bakery products which have not been mixed with talc.

Furthermore, a food mixed with talc has a better shelf life, wherein in particular the infestation of bacteria can be reduced, wherein a reason for that being also the lower nutritional value. For example the formation of mold is slowed down which in turn improves the storage life.

Preferably, a food according to the present invention serves as a partial substitute and more preferably a complete substitute of an in-between meal. Particularly preferably, a food according to the present invention is suitable for supplementing a main meal. In a particular embodiment the food is suitable for completely substituting a main meal. According to the present invention the term main meal comprises the categories breakfast, lunch and dinner. In-between meals are meals which are in addition to the main meals, and they comprise elevenses (second breakfast) and coffee time.

Foods according to the present invention are preferably intended for the consumption through human beings. Particularly preferably, foods according to the present invention are exclusively used with human beings.

Due to the different specific heats of talc and of flour the foods which are prepared by baking can be prepared at lower temperatures. So temperatures of 150° C. to no more than 180° C. are sufficient as the baking temperature, whereas respective baking mixtures in which no portion has been replaced by talc have to be baked at temperatures of 185° C. to 200° C. In the industrial production of foods such a lowering of the temperature has a considerable effect onto the consumption of energy. As a consequence, the foods according to the present invention can be produced in an energy-saving and thus environmentally friendly way.

According to the present invention it was also possible to show that the addition of talc to the foods which are produced by baking does not disturb the baking process. Due to the following reasons this is surprising:

The processes during the baking procedure are complex. Initially, the baking heat spreads from the outside of the dough piece to the inside thereof. The doughy core of the bakery product is gradually transformed into a hard crumb, such as for example the bread crumb. At the same time the wet surface of the bakery product is gradually transformed into a hard and embrowned crust. Here, simultaneously different transformation processes proceed depending on the achieved temperature. While in the core a doughy material is still present, the crumb in the edge region has already been hardened and on the surface already a crust has been formed. During the formation of the crumb the following processes proceed: The dough is put into the oven at cooking chamber temperature. The core temperature of the dough during baking only increases slowly. Initially here, between 35° C. and 45° C. a strong activity of enzymes and yeast occurs. This results in an increase of the pores of the dough by gas expansion. Therefore, bulging out and a strong increase of volume of the bakery product result (also referred to as ‘oven rise’). Then, at a temperature of higher than 50° C. the baking yeast is inhibited. At temperatures of 53° C. to 60° C. acid formers and yeast cells die. Between 60° C. and 80° C. protein substances coagulate and during this coagulation they again release that water which they have absorbed during the formation of the dough. Starch, such as for example rye starch, gelatinizes at temperatures of between 53° C. and 73° C. During this process it absorbs dough water and the water which has been released during protein coagulation. The process is a decisive step for the formation of a stable bread crumb. With the increasing inner temperature in the bread crumb formed volatile substances evaporate, such as for example grain alcohols at a temperature of higher than 78° C. Partially, they react with the acids of the dough to aroma substances via a reaction of acids and alcohols to esters. Finally, at temperatures of higher than 98° C. water begins to evaporate. This is the reason for the loss of weight during baking.

In the light of the complex baking process described above it is a surprising advantage according to the present invention that the addition of talc to a food, such as a bakery product, does not result in an impairment of the baking process and that in addition the bakery product can be baked with reduced energy consumption.

The addition of talc to baking mixtures may even result in a lower pollution of the bakery products with undesired by-products of the baking process, such as for example acrylamide, in comparison to common bakery products. Acrylamide is preferably formed during dry baking processes in foods having a high content of starch and which are exposed to temperatures of higher than 180° C. for longer time periods during production.

The use of talc according to the present invention, for example in baking mixtures for a partial substitution of flour the main component of which is starch as well as other carbohydrates (wherein they also include the monosaccharides glucose and fructose) reduces on the one hand the portion of exactly those substances which are known as substances promoting the formation of acrylamide.

Furthermore, the maximum baking temperature of baking mixtures mixed with talc can be reduced to temperatures of between 150 to 180° C., as already mentioned above, thus exactly below the temperature limit at which an increased formation of acrylamide can be observed as has been proven.

According to the present invention carbohydrates in food can be replaced by talc. According to a preferable embodiment this concerns flour. In this case any type of flour can be replaced. A person skilled in the art will assess the nature of the flour to be replaced and of the respectively used talc, and will conduct a suitable substitution. For example, the flour may be wheat flour, rye flour or any other kind of flour of the different types. According to the present invention talc and flour can be used in a food as a mixture in ratios of 1 part of talc to 1.5 parts of flour up to 1 part of talc to 9 parts of flour.

According to the present invention talc can be used as a substitute for flour in for example, but not limited to bread, in particular grains, whole-grain and bio bread, rolls, pretzels, baguette, puff pastry and brioche dough products, yeast dough, short pastry, folded and rolled dough and other dough products. They can also be cake doughs, other doughs for sweet pastries or for example ready-to-use mixtures for pancake batters.

When talc is added to a food, such as for example for replacing a portion of flour in the food, a person skilled in the art will select the bulk density of the talc according to the respective value of the flour dependent on the type of flour.

According to the present invention talc can also be used as a substitute for a carbohydrate-containing component, such as for example rolls in sliced bread dumplings cooked in a napkin. In this case up to 40 wt % of talc are present in the dumpling relative to the whole food. Amounts of talc according to the present invention are 15 wt % to 40 wt %, preferably 15 wt % to 35 wt %, more preferably 20 wt % to 30 wt %.

For example a bread may comprise wheat flour, rye flour, salt, yeast, water and sour dough. According to the present invention up to 40 wt % of talc may be present in the bread relative to the total weight of the bread. Amounts of talc according to the present invention are 15 wt % to 40 wt %, preferably 15 wt % to 35 wt %, more preferably 20 wt % to 30 wt %.

According to the present invention the addition of talc to the food may also replace fat-containing portions of the food, such as for example butter, margarine or oil. With this a considerable reduction of calories is achieved. Dependent on the food talc can replace fat, wherein this may be effected independently of or additionally to the substitution of a carbohydrate-containing portion.

In the case of simultaneous substitution of for example flour with talc and fat with talc in one food it has proved successful to replace amounts of about 2 wt % to 10 wt % of the fat by talc relative to the total portion of fat in the food. Preferably, amounts of fat of between 4 wt % and 8 wt % are replaced by talc relative to the total amount of fat, more preferably between 4.5 wt % and 5.5 wt % and most preferably about 5 wt %. In total the portion of talc in the food is at least 15 wt % up to 40 wt % relative to the whole food.

Due to the hydrophobic and oleophilic properties of talc it is also suitable as an additive for oils. For example in the case of production of mayonnaise the replacement of a part of the oil by talc can be a contribution to a controlled emulsification thereof, while at the same time the content of oil is reduced. According to the present invention a reduced-calorie oil comprises between 15 wt % and 40 wt % of talc, preferably between 15 wt % and 35 wt %, more preferably 20 wt % and 30 wt %. The same holds true for a reduced-calorie cream. Such a cream may be used in cream mousses, fancy cakes or other confectionaries.

Furthermore, it is even assumed that additions of talc may compromise the resorption of fat in the human bowel and may also thereby reduce the nutritional value of the food.

Furthermore, through its fatlike consistency talc serves as a good carrier for flavoring and aroma substances.

Its good miscibility with other supplements in different foods is also an advantage.

### EMBODIMENT EXAMPLES

1. Rye Bread

For 1 kg of rye bread 600 g of rye flour and 400 g of talc are mixed with about 1 teaspoon of salt. One cube of fresh yeast is carefully heated in about 20 ml of milk with a pinch of sugar, until the yeast rises. With the addition of a suitable amount of lukewarm water into which also salt may be mixed according to the desired taste, from the mixture of flour and talc and the yeast a homogenous dough is produced and kneaded into a suitable shape. The shaped dough is stored in a clay mold at a temperature of 50° C. in an oven for about one hour, until it has risen. Thereafter, the bread is baked on a baking sheet, at first for 10 minutes at a temperature of 250° C., then for additional 50 minutes at a temperature of 175° C. for finishing.

Table 1 contains a comparison of the nutritional value of a bread which has been produced in this way and a rye bread which has been produced according to a traditional recipe (without the addition of talc):

TABLE 1
Ingredients and nutritional values of a rye bread according to the
present invention and a standard recipe for rye bread in comparison

| | Standard recipe | | Recipe according to | |
|---|---|---|---|---|
| | Mass; volume | | the present invention | |
| | (for liquids) | Nutritional | Mass | Nutritional |
| Ingredients | [g]; [ml] | value [~kcal] | [g] | value [~kcal] |
| Rye flour | 1000 | 3240 | 600 | 1944 |
| (type: 650-1800) | | | | |
| Plustalc ® H30 | 0 | 0 | 400 | 0 |
| Whole milk | 20 | 13 | 20 | 13 |
| (3.5% of fat) | | | | |
| Yeast (fresh) | 42 | 132 | 42 | 132 |
| Sugar (white) | 10 | 41 | 10 | 41 |
| Table salt | 10 | 0 | 10 | 0 |
| Sum | 1082 | 3426 | 1082 | 2130 |
| | | (100%) | | (62.2%) |

Thus, a rye bread produced according to a recipe according to the present invention has a nutritional value that is nearly 38% lower than the nutritional value of a rye bread which has been produced according to a standard recipe.

2. Stirred Cake

300 g of wheat flour (type 405) are mixed with 100 g of talc. To that 1 teaspoon of baking powder is added. 125 g of butter are heated, until the butter is nearly melted. The fat is mixed with the mixture of flour and talc and under stirring 2 eggs and 100 g of sugar as well as a sachet of vanilla sugar or vanilla sugar are added. The dough is placed in a suitable mold and baked for about 45 to 50 minutes at a temperature of 175° C. A person skilled in the art will enrich the dough mixture described herein in any way with different spices—according to personal preferences—which however—measured in relation to the calorific value of the components mentioned here—only contribute a little amount to the total calorific value of the food and thus can be neglected in its calculation.

The table below contains a comparison of the recipes and the calorific values of a stirred cake produced according to the present invention and a stirred cake produced according to a standard recipe (without the addition of talc):

TABLE 2
Ingredients and nutritional values of a stirred cake according to the present invention
and a standard recipe for a stirred cake in comparison

| | | | Recipe according to the present | |
|---|---|---|---|---|
| | Standard recipe | | invention | |
| | Mass; volume (for | Nutritional | Mass | Nutritional |
| Ingredients | liquids) [g]; [ml] | value [~kcal] | [g] | value [~kcal] |
| Wheat flour | 300 | 1005 | 160 | 510 |
| (type: 450) | | | | |
| Wheat flour-vital- | 0 | 0 | 5 | 3 |
| gluten | | | | |
| Plustalc ® H30 | 0 | 0 | 180 | 0 |
| Butter | 100 | 866 | 95 | 822 |
| Sugar (white) | 100 | 400 | 0 | 0 |
| Artificial | 0 | 0 | ~15 | 0 |
| sweetener | | | | |
| Eggs | 3 | 252 | 3 | 252 |
| Whole milk | 25 | 16 | 80 | 32 |
| (3.5% of fat) | | | | |
| Table salt | 10-15 | 0 | 10-15 | 0 |
| Vanilla sugar | 10 | 41 | 5 | 20 |
| Vanilla aroma | 0 | 0 | 5 | 15 |
| Baking powder | 15 | 23 | 20 | 31 |
| Sum | 553 | 2603 | 553 | 1685 |
| | | (100%) | | (64.7%) |

Thus, a stirred cake produced according to a recipe according to the present invention has a nutritional value that is more than 35% lower than the nutritional value of a stirred cake which has been produced according to a standard recipe.

3. Pasta

For the production of a pasta on the basis of durum wheat semolina a mixture consisting of about 65% of durum wheat semolina and about 35% of Plustalc H30 is mixed in a modern continuous double screw kneader to a homogenous dough. A person skilled in the art will enrich a mixture produced in this manner in any way with different herbs and spices—according to personal preferences—which however—measured in relation to the calorific value of the components mentioned here—only contribute a little amount to the total calorific value of the food and thus can be neglected in its calculation. Before the addition of the talc to the durum wheat semolina the talc should already has been mixed with the required amount of water. This measure considerably supports the homogenization of the mixture of talc and semolina.

The kneading of the mixture in the kneader, besides the homogenous mixing of the mixture also results in a sufficient activation of gluten in the wheat.

Subsequently, the kneaded mixture is pressed through shaping dies with a single screw pasta press which is known in prior art to obtain the desired shapes. A subsequent drying process to equilibrium humidity results in a pasta with good shelf life.

In the following table the nutritional values of a pasta recipe based on the addition of talc according to the present invention and a pasta standard recipe are compared with each other:

TABLE 3
Ingredients and nutritional values of a pasta according to the present
invention and a standard recipe for a pasta in comparison

| | | | Recipe according to the | |
|---|---|---|---|---|
| | Standard recipe | | present invention | |
| | Mass | Nutritional | Mass | Nutritional |
| Ingredients | [g] | value [~kcal] | [g] | value [~kcal] |
| Durum wheat | 860 | 2881 | 559 | 1873 |
| semolina | | | | |
| Plustalc ® H30 | 0 | 0 | 301 | 0 |
| Water | 140 | 0 | 140 | 0 |
| Sum: | 1000 | 2881 | 1000 | 1873 |
| | | (100%) | | (65.0%) |

A pasta according to the present invention with the ingredients as shown in table 3 has a nutritional value which is 35% lower than the nutritional value of a standard pasta.

4. Candies, e.g.: Marzipan

To a homogenous mixture of a composition comprising 190 grams of powdered sugar, 360 grams of Plustalc H50, a few milliliters of bitter almond aroma and vanilla aroma 450 grams of heated marzipan paste are added. The mixture produced in this manner is homogenously mixed in a kneader.

TABLE 4
Ingredients and nutritional values of a marzipan mixture according
to the present invention and a standard recipe for marzipan

| | | | Recipe according to | |
|---|---|---|---|---|
| | Standard recipe | | the present invention | |
| | Mass | Nutritional | Mass | Nutritional |
| Ingredients | [g] | value [~kcal] | [g] | value [~kcal] |
| Marzipan paste | 670 | 3478 | 445 | 2310 |
| Plustalc ® H50 | 0 | 0 | 360 | 0 |
| Powdered sugar | 330 | 1320 | 185 | 740 |
| Water | 0 | 0 | 0-5 | 0 |
| Bitter almond | 0 | 0 | 5 | 35 |
| aroma | | | | |
| Vanilla aroma | 0 | 0 | 5 | 15 |
| Sum: | 1000 | 4798 | 1000 | 3100 |
| | | (100%) | | (64.6%) |

A marzipan mixture prepared according to the present invention has a nutritional value which is more than 35% lower than the nutritional value of a common marzipan mixture.

According to the present invention there are virtually no limits with respect to the eagerness to experiment of a person skilled in the art in the selection of further aromas for the elaboration of the taste of the marzipan mixture.

Plustalc® is a brand name of the company Mondo Minerals. Plustalc® products are talc with high purity which is suitable as an additive for dishes and which is free of additives being harmful to health or toxic, in particular heavy metals, which is a certified property of these products. Furthermore, due to the production process the product is free of pathogenic microorganisms. Basically, the reason for that is that the substances are exposed to high temperatures during the grinding process due to the heat produced during that, resulting in sterilization of the products.

The different kinds of Plustalc® mentioned here, e.g. H10, H30, H50, differ from each other with respect to grain size and physical and chemical properties associated therewith.

Plustalc® is only one possible option of a suitable kind of talc for the preparation of dishes according to the present invention. When a talc-containing dish according to the present invention is prepared, a person skilled in the art is able to select respective substances from the broad range of talc kinds which are available on the market. Kinds of talc which are preferable according to the present invention have high purity, e.g. they are free of additives which are harmful to health or toxic, in particular heavy metals, and they are suitable as additives for dishes. Particularly preferably, Plustalc® products are used.

Plustalc® H10 has the following specifications:

| | |
|---|---|
| Content of talc [wt %] | 96 |
| Index of whiteness/brightness CIE L* [%] (DIN 6174) | 98.0 |
| Index of whiteness/brightness Ry [%] (DIN 53163) | 95 |
| Mean particle size d50 [μm] (Sedigraph) | 2.2 |
| Top cut d98 [μm] (Sedigraph) | 9 |
| Oil absorption [g/100 g] (ISO 787/5) | 47 |
| Specific surface area [m²/g] (ISO 6452) | 10.5 |
| Ignition loss [%] (DIN 53163, 1000° C.) | 5.5 |

Plustalc® H30 has the following specifications:

| | |
|---|---|
| Content of talc [wt %] | 96 |
| Index of whiteness/brightness CIE L* [%] (DIN 6174) | 97.0 |
| Index of whiteness/brightness Ry [%] (DIN 53163) | 93 |
| Mean particle size d50 [μm] (Sedigraph) | 8.0 |
| Top cut d98 [μm] (Sedigraph) | 26 |
| Oil absorption [g/100 g] (ISO 787/5) | 33 |
| Specific surface area [m²/g] (ISO 6452) | 6.0 |
| Ignition loss [%] (DIN 53163, 1000° C.) | 5.5 |

Plustalc® D30E has the following specifications:

| | |
|---|---|
| Content of talc [wt %] | 96 |
| Index of whiteness/brightness CIE L* [%] (DIN 6174) | 97.0 |
| Index of whiteness/brightness Ry [%] (DIN 53163) | 91 |
| Mean particle size d50 [μm] (Sedigraph) | 10.0 |
| Top cut d98 [μm] (Sedigraph) | 24 |
| Oil absorption [g/100 g] (ISO 787/5) | 28 |
| Specific surface area [m²/g] (ISO 6452) | 4.7 |
| Ignition loss [%] (DIN 53163, 1000° C.) | 5.5 |

Plustalc® D40 has the following specifications:

| | |
|---|---|
| Content of talc [wt %] | 96 |
| Index of whiteness/brightness CIE L* [%] (DIN 6174) | 97.0 |
| Index of whiteness/brightness Ry [%] (DIN 53163) | 91 |
| Mean particle size d50 [μm] (Sedigraph) | 18.0 |
| Top cut d98 [μm] (Sedigraph) | 45 |
| Oil absorption [g/100 g] (ISO 787/5) | 26 |
| Specific surface area [m²/g] (ISO 6452) | 4.5 |
| Ignition loss [%] (DIN 53163, 1000° C.) | 5.5 |

1. A food having a calorific value-containing portion, characterized in that it contains talc in a portion of at least 15 wt % relative to the total weight of the food, wherein at least one calorific value-containing component of the calorific value-containing portion of the food is partially or completely replaced by talc.

2. The food according to claim 1, wherein the food contains talc in a portion of no more than 40 wt % relative to the total weight of the food.

3. The food according to claim 1, wherein at least two calorific value-containing components of the calorific value-containing portion of the food are partially or completely replaced by talc.

4. The food according to claim 3, wherein the calorific value-containing portion is selected from carbohydrates, proteins or fats.

5. The food according to claim 4, wherein the calorific value-containing portion is at least 50 wt % relative to the whole food.

6. The food according to claim 5, wherein in the food at least 50 wt % of carbohydrates are present relative to the whole food.

7. The food according to claim 6, wherein in the food at least 30 wt % of fat are present relative to the whole food.

8. The food according to claim 7, wherein in the food at least 30 wt % of protein are present relative to the whole food.

9. A method of reducing the calorific value of a food, comprising replacing in total at least 15 wt % of a calorific value-containing portion of the food relative to the total weight of the food by talc.

10. The method of claim 9, wherein no more than 40 wt % of a calorific value-containing portion of the food relative to the total weight of the food are replaced by talc.
